(19) United States
(12) Patent Application Publication
(10) Pub. No.: US 2025/0125073 A1
(43) Pub. Date: Apr. 17, 2025

(54) CREEPAGE EXTENDER SYSTEM

(71) Applicant: BARRY CORDAGE LTD., Montreal (CA)

(72) Inventors: Peter BARRY, Town of Mount Royal (CA); Patrick BARRY, Etobicoke (CA)

(73) Assignee: BARRY CORDAGE LTD., Montreal (CA)

(21) Appl. No.: 18/913,681

(22) Filed: Oct. 11, 2024

Related U.S. Application Data
(60) Provisional application No. 63/589,650, filed on Oct. 12, 2023.

(51) Int. Cl. H01B 17/42

(52) U.S. Cl. CPC H01B 17/42

(57) ABSTRACT

A creepage extender system includes a first creepage extender portion; and a second creepage extender portion, the second creepage extender portion being configured to be detachably coupled to the first creepage extender portion, the second creepage extender portion, when coupled to the first creepage extender portion, defining an aperture configured to receive an insulation tool.

### CROSS-REFERENCE TO RELATED APPLICATIONS

This application claims priority from U.S. Provisional Application Ser. No. 63/589,650, titled CREEPAGE EXTENDER SYSTEM and filed Oct. 12, 2023.

### TECHNICAL FIELD

The present technology relates to the field of insulation devices for power transmission, and more particularly, to creepage extenders.

### BACKGROUND

In electrical insulation tools and components, conventional creepage extenders also commonly referred to as sheds are preferred for safeguarding against streamers, electrical discharge, contamination, and flashover events. The conventional creepage extenders break up water and improve icing performance. Conventionally, the creepage extenders have been constructed from heat-shrinkable materials with a low dielectric constant such as silicon rubber and are affixed to various components, such as metal conductors, wires, and Fiber Reinforced Polymer (FRP) insulated tools. A cold-shrink, slip-on version using mastic to adhere to surfaces exists.

However, the conventional methods may have certain drawbacks. Firstly, once installed, the conventional creepage extenders are not easily removable if damaged, requiring cutting for replacement. Secondly, the conventional creepage extenders tend to deform when stored with the tool, potentially affecting their functionality. Additionally, the conventional creepage extenders may trap dirt and impurities that are difficult to remove, posing challenges in maintaining their effectiveness. Cold shrink creepage extenders do not create an airtight finish creating gaps between sheds and surface which can let flashovers pass through such gaps. Conventional heat shrink or cold shrink creepage extenders are often fragile and can permanently weaken the underlying material when heat is applied to initiate the shrinking process. Lastly, when a plurality of spaced apart creepage extenders are installed on an insulation tool, such as a hot stick, replacing a creepage extenders in the middle of a series of creepage extender by a heat shrink method means having to replace other creepage extenders in order to provide slip-on access to the damaged creepage extender that is to be replaced. This results in waste of otherwise functional creepage extenders that have to be removed.

These limitations underscore the need for improved creepage extenders for electrical insulation tools and components.

### SUMMARY

As mentioned earlier, the conventional creepage extenders rely on the use of flexible materials such as silicon rubber or ethylene vinyl acetate (EVA) which may be wrapped around the insulator or formed as a cone which is slipped over the rod and heat shrunk and glued into place which may weaken the underlying material due to the high heat applied on small areas and which may trap conductive dirt which is not easily removed or cleaned.

Creep distance is also referred to as leakage distance. It represents the shortest distance along the surface of the insulator between the conductive ends of the insulator. In a typical insulator application, one end would be at an elevated voltage level and the other end would be at a lower voltage or grounded.

IEEE Std 100-1992 defines leakage distance as “The sum of the shortest distances measured along the insulating surfaces between the conductive parts.”

The contemplated improvement includes implementing a creepage extender system in at least a two-part arrangement which fits around the outside perimeter of an insulation and is assembled using any suitable coupling mechanism. The creepage extender system, in accordance with various embodiments of the present disclosure, may have various benefits over the conventional creepage extender. Such benefits may include but are not limited to easy installation on a variety of insulated tools and which produces a tight fit yet can be easily removed to enable inspection and cleaning. The creepage extender system may extend the creepage distance, shed moisture and may reduce significantly the risk of flashover. The creepage extender system, in accordance with various embodiments of the present disclosure may act as a storm shed and make the insulation tool more robust and also act as a minimum approach distance (MAD) marker. The creepage extender system may act to protect hot sticks when it is laid and slid into tubes for storage on vehicles or in stations.

According to a broad aspect, a creepage extender system comprises a first creepage extender portion and a second creepage extender portion, the second creepage extender portion being configured to be detachably coupled to the first creepage extender portion; when the second creepage extender portion is coupled to the first creepage extender portion, the creepage extender system defines an aperture configured to receive an insulation tool.

In embodiments, the first creepage extender portion has a first inner portion and a first outer portion, the first inner portion having a first wall and a second wall separated by a first predefined distance, the first outer portion defining a first outer sector; and the second creepage extender portion has a second inner portion and a second outer portion, the second inner portion having a third wall and a fourth wall separated by a second predefined distance, the second outer portion defining a second outer sector.

In embodiments, the first wall and the second wall include through openings that extend from the first outer portion, configured to receive fasteners, and the third wall and the fourth wall include recesses configured to hold the fasteners.

In embodiments, the first wall, the second wall, the third wall, and the fourth wall define couplers.

In embodiments, the couplers are arranged in a snap fit arrangement.

In embodiments, the couplers are arranged to receive screws for securing together the first and second creepage extender portions.

In embodiments, the first inner portion further comprises a first inner sector defined between the first wall and the second wall and the second inner portion further comprises a second inner sector defined between the third wall and the fourth wall.

In embodiments, a length of the first inner sector is one of longer than a length of the second inner sector, shorter than the length of the second inner sector, and equal to the length of the second inner sector.

In embodiments, the first inner portion further comprises a first rectangular portion defined between the first wall and the second wall and the second inner portion further comprises a second rectangular portion defined between the third wall and the fourth wall.

In embodiments, a length of the first rectangular portion is one of longer than a length of the second rectangular portion, shorter than the length of the second rectangular portion, and equal to the length of the second rectangular portion.

In embodiments, a length of the first outer sector is one of longer than a length of the second outer sector, shorter than the length of the second outer sector, and equal to the length of the second outer sector.

In embodiments, the first inner portion and the second inner portion further comprise a layer of elastic material.

In embodiments, the first inner portion and the second inner portion further comprise a compressible layer comprising a compressible material, the compressible layer extending radially into at least a portion of the aperture.

In embodiments, the compressible layer is configured for at least partial compression between the insulation tool and at least one of the first and second creepage extender portions.

In embodiments, the aperture is at least one of a circular aperture, a rectangular aperture, a triangular aperture, and an oval aperture.

In embodiments, a kit of parts comprises the creepage extender system as described above together with assembly instructions.

In embodiments, the system comprises one or more materials selected from Ultra-High Molecular Weight Polyethylene, cast nylon, polyurethane, polytetrafluoroethylene, polyvinylchloride, polyvinyl ether, polypropylene, nylon, polycarbonate, HDPE, fiberglass, fiber-reinforced polymer, polyurethane and ceramic.

Implementations of the present technology each have at least one of the above-mentioned objects and/or aspects, but do not necessarily have all of them. It should be understood that some aspects of the present technology may satisfy other objects or provide other advantages not specifically recited herein but which will be apparent to a skilled person.

Additional and/or alternative features, aspects and advantages of implementations of the present technology will become apparent from the following description, the accompanying drawings and the appended claims.

### BRIEF DESCRIPTION OF THE DRAWINGS

Having thus generally described the nature of the technology, reference will now be made to the accompanying drawings, showing by way of illustration example implementations thereof and in which:

FIG. 1 illustrates a representative creepage extender system in accordance with various non-limiting embodiments of the present disclosure;

FIG. 2 illustrates an exploded view of the creepage extender system, in accordance with various non-limiting embodiments of the present disclosure;

FIG. 3 illustrates a top planner view of the creepage extender system, in accordance with various non-limiting embodiments of the present disclosure;

FIG. 4 illustrates a side planner view of the creepage extender system, in accordance with various non-limiting embodiments of the present disclosure;

FIG. 5 illustrates creepage extender systems mounted on an insulation tool, in accordance with various non-limiting embodiments of the present disclosure; and

FIG. 6 illustrates another representative creepage extender system, in accordance with various non-limiting embodiments.

FIGS. 7A and 7B show views of an exemplary creepage extender system according to an embodiment.

FIGS. 8A and 8B show the system of FIGS. 7A and 7B, comprising fasteners.

FIG. 9 shows a detail of the creepage extender system of FIGS. 7A and 7B.

FIG. 10 shows the system of FIGS. 7A and 7B comprising indicia.

FIG. 11 shows an exemplary collar for the creepage extender system of FIG. 1.

FIG. 12 shows a creepage extender system installed on an aerial device boom.

FIG. 13 shows a creepage extender system installed on a ladder.

FIG. 14 shows a creepage extender system installed on a fiber-reinforced polymer pole.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “wall” and “third wall” is not intended to imply any particular order, type, chronology, hierarchy or ranking (for example) of/between the ends, nor is their use (by itself) intended to imply that any “second wall” must necessarily exist in any given situation.

Moreover, all statements herein reciting principles, aspects, and implementations of the present technology, as well as specific examples thereof, are intended to encompass both structural and functional equivalents thereof, whether they are currently known or developed in the future.

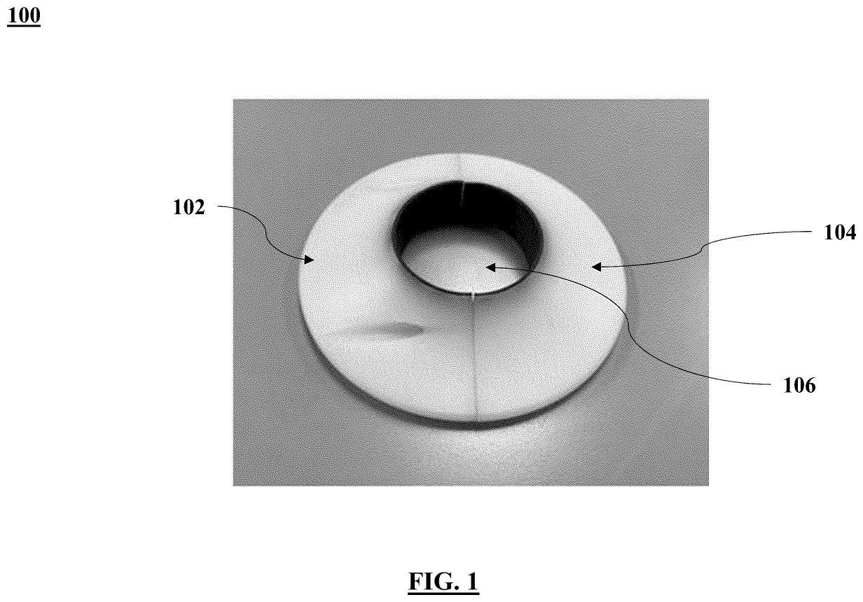

FIG. 1 illustrates a creepage extender system 100 for safeguarding insulation tools, such as, for example, Fiber Reinforced Polymer (FRP) insulated hand tools, strain poles, epoxy glass ladders, link sticks, wire tongs, dielectric insulating work and rescue ropes, dielectric helicopter longlines, boom trucks or the like against streamers, electrical discharge, contamination, and flashover events. The creepage extender system 100 may be employed in insulation tools used for electrical insulation work, such as in the field of electrical maintenance or high-voltage applications. In this context, the creepage extender system 100 may serve to enhance safety and prevent electrical accidents when working with insulation tools in high-voltage or potentially hazardous environments.

In certain non-limiting embodiments, the creepage extender system 100 may be applied to the insulation tools to increase the creepage distance between the conductive parts of the tool and the user's hand or any other potential contact surface. The creepage distance may also be referred to as leakage distance. The creepage distance may represent the shortest distance along the surface of the creepage extender system 100 between the conductive ends of the creepage extender system 100. One end of the creepage extender system 100 may be at an elevated voltage level and the other end may be at a lower voltage or grounded. The creepage extender system 100 may serve to mark the minimum approach distance (MAD) to protect the end-user. Enhancing the creepage distance in insulation tools may reduce the risk of electrical arcing or discharge from occurring along the tool's surface and thus enhances safety.

As previously noted, the conventional creepage extenders have several drawbacks. To overcome the drawbacks of the conventional creepage extenders, the creepage extender system 100 may be divided into a first creepage extender portion 102 and a second creepage extender portion 104. The creepage extender system 100 may include other components, however such components have been omitted from FIG. 1 for the purpose of simplicity.

The second creepage extender portion 104 may be configured to be coupled to the first creepage extender portion 102. In certain non-limiting embodiments, the second creepage extender portion 104 may be detachably coupled to the first creepage extender portion 102. The second creepage extender portion 104 when coupled to the first creepage extender portion 102 may define an aperture 106 configured to receive the insulation tool. Even though the illustrated aperture 106 has a circular shape, in various other embodiments, the aperture 106 may have any suitable shape, such as, oval, triangular, square, rectangular, or the like without limiting the scope of the present disclosure.

The creepage extender system 100 may be constructed of any suitable robust material that has a low dielectric constant (k) value, such as, for example, Polypropylene, Nylon, Polycarbonate, HDPE, cast nylon (Nycast), Fiberglass, FRP, Ultra-High Molecular Weight Polyethylene (UHMWPE), Polytetrafluoroethylene (PTFE), Polyvinyl Ether (PVE), polyvinylchloride (PVC), polyurethane, ceramic, and/or other man-made synthetic materials and composites or the like.

The creepage extender system 100 may be fabricated using premium materials known for their outstanding non-tracking characteristics, insulation properties, and long-term service dependability. Additionally, the creepage extender system 100 may exhibit favorable physical attributes, robust aging stability, and resistance to factors such as wear and tear, chemicals, and ultraviolet (UV) radiation. Further, the surface of the creepage extender system 100 may provide a high luster for beading of moisture that causes water or moisture to form into small, round droplets rather than spreading out or adhering to the surface.

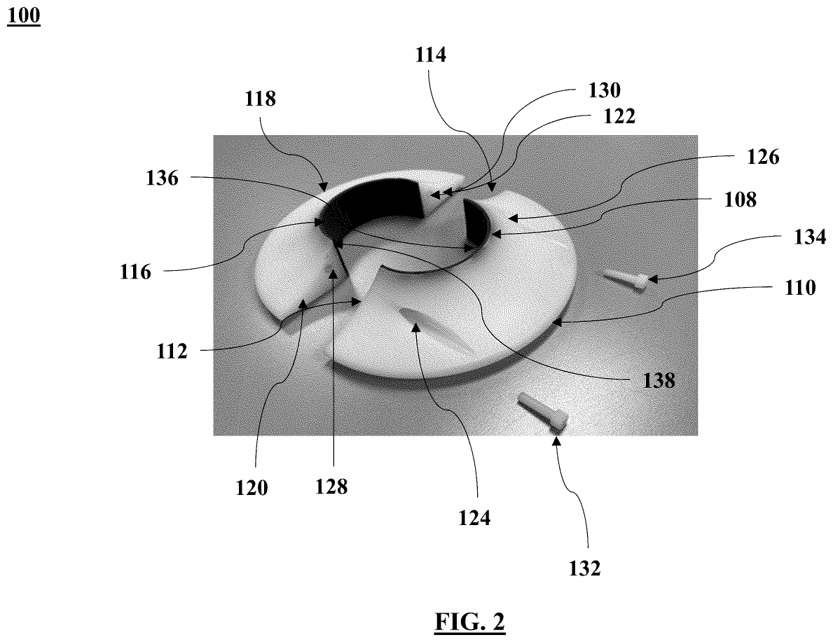

FIG. 2 illustrates an exploded view of the creepage extender system 100, in accordance with various non-limiting embodiments of the present disclosure. As shown, the first creepage extender portion 102 may have a first inner portion 108 and a first outer portion 110. The first inner portion 108 may have a first wall 112 and a second wall 114. The first wall 112 and the second wall 114 may be separated by a first predefined distance. The first inner portion 108 may further comprise a first inner sector 136 contracting radially between the first wall 112 and the second wall 114. The first predefined distance may be equal to the diameter of the first inner sector 136. The first inner sector 136 may be provided with a layer of elastic material, for example, rubber, to enhance a grip of the creepage extender 100 on the insulation tool. Further, the first outer portion 110 may be defined by a first outer sector radially extending from the first wall 112 to the second wall 114.

In a similar manner, the second creepage extender portion 104 may have a second inner portion 116 and a second outer portion 118. The second outer portion 118 may be defined by the second outer sector. The second inner portion 116 may have a third wall 120 and a fourth wall 122. The third wall 120 and the fourth wall 122 may be separated by a second predefined distance. The second inner portion 116 may further comprise a second inner sector 138 contracting radially between the third wall 120 and the fourth wall 122. The second predefined distance may be equal to the diameter of the second inner sector 138. The second inner sector 138 may be provided with a layer of elastic material, for example, rubber, to enhance a grip of the creepage extender system 100 on the insulation tool. Further, the second outer portion 118 may be defined by a second outer sector radially extending from the third wall 120 to the fourth wall 122. When assembled, the creepage extender system 100 may define an aperture having a diameter, or at least one axial width, of between 1 inch and 4 inches, for example between about 1¾ inches and 3 inches.

The first inner sector 136 and the second inner sector 138 may be provided with a resilient and/or compressible layer or liner (not shown) configured to contact the insulation tool for reducing voids and/or for improving the watertightness of the creepage extender system 100. It is understood that fluids and air may conduct electricity and thereby contribute to personnel injury due to current leakage and flashovers. The resilient and/or compressible layer is provided on an inner face of the inner sectors 136, 138 such that, when the creepage extender system 100 is installed on an insulation tool, the resilient and/or compressible layer is at least partly compressed between the insulation tool and the inner sectors 136, 138. The presence of air gaps is thereby reduced and fluids are substantially prevented from infiltrating between the insulation tool and the creepage extender system 100. The compressible material may comprise rubber, neoprene, polyurethane and/or other suitable materials for providing watertightness and electric insulation.

The first outer portion 110 and the first inner sector 136 have been illustrated to be equal to the second outer portion 118 and the second inner sector 138 respectively. In other words, the size of the first creepage extender portion 102 may be equal to the size of the second creepage extender 104. However, in various non-limiting embodiments, a length of the first inner sector 136 may be longer or shorter than a length of the second inner sector 138. Similarly, the length of the first outer portion 110 may be longer or shorter than the length of the second outer portion 118. That is, the first creepage extender 102 and the second creepage extender portion 104 may not need to be of equal size. One of the first creepage extender 102 and the second creepage extender portion 104 may be smaller in size as compared to the other, while still maintaining the size of the aperture 106 and the overall size of the creepage extender system 100.

Further the first creepage extender portion 102 may be coupled to the second creepage extender portion 104 by any suitable mechanism. In one non-limiting embodiment, the first creepage extender portion 102 may be coupled to the second creepage extender portion 104 via fasteners 132 and 134. The first wall 112 and the second wall 114 may include through openings 124 and 126 extending from the first outer portion 110. The through openings 124 and 126 may be configured to receive the fasteners 132 and 134 respectively. In some non-limiting embodiments, at least a portion of the through openings may be threaded. To receive and hold the fasteners 132 and 134, the third wall 120 and the fourth wall 122 of the second creepage extender 104 may include recesses 128 and 130. The recesses 128 and 130 may be aligned with the through openings 124 and 126 to receive the fasteners 132 and 134. In certain non-limiting embodiments, the recesses 128 and 130 may be cylindrical and at least a portion of the recessed 128 and 130 may be threaded.

In other non-liming embodiments, the first wall 112, the second wall 114, the third wall 120, and the fourth wall 122 may be provided with couplers to couple the first creepage extender portion 102 to the second creepage extender portion 104. Such couplers may include but are not limited to snap fit arrangement, interlocking tabs arrangement, press fit arrangement, screwed together arrangement (using dielectric screws preferably made of the same or similar material as the creepage extender portions), or the like. When the first and second portions 102, 104 are coupled together using screws, the screws may be self-drilling and/or self-tapping, or be otherwise configured for cutting a thread into a material during use, thereby reducing or eliminating the need for complementary threaded holes in the corresponding portion. Reducing the number and/or size of holes in the creepage extender system 100 simplifies component manufacture and reduces areas where humidity, debris, contaminants or fluids may accumulate prior to and during use of the system 100. Accordingly, production costs can be reduced while improving personnel safety and product longevity. The fasteners may comprise reinforced plastic, for example fiberglass-reinforced plastic and/or glass-filled nylon. Reinforcement allows the fasteners to be used reliably in the field when assembling the creepage extender system 100 while reducing or eliminating fastener breakage.

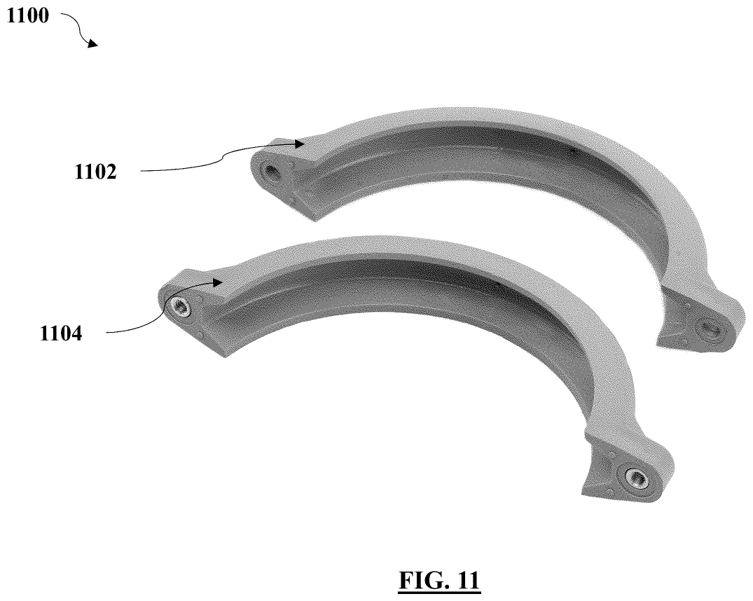

Referring to FIG. 11, the creepage extender system may be configured to allow the coupling of the first portion 102 and the second portion 104 using a collar 1100. In the exemplary embodiment illustrated in FIG. 11, the collar 1100 comprises two portions 1102 and 1104 configured to be coupled together, for example using screws. Accordingly, the creepage extender system 100 may define complementary recesses, coupling arrangements or other suitable features for receiving the collar 1100 and having the collar 1100 secured thereto. Other configurations are possible. For example, the collar may comprise a clamp ring configured to be clamped and/or tightened around the creepage extender system 100 to couple the first portion 102 and the second portion 104 together, for example by being fitted to the outer edge of the creepage extender sheds. The collar 1100 may comprise suitable insulating materials similar to the materials suitable for the creepage extender sheds.

In another configuration, the sheds may comprise an extender collar and be configured to be secured using one collar on an upper portion of the shed and a second collar on a lower portion of the shed. The upper and lower collars may be held together with a zip-tie or other means. Accordingly, the need for screws may be reduced or eliminated.

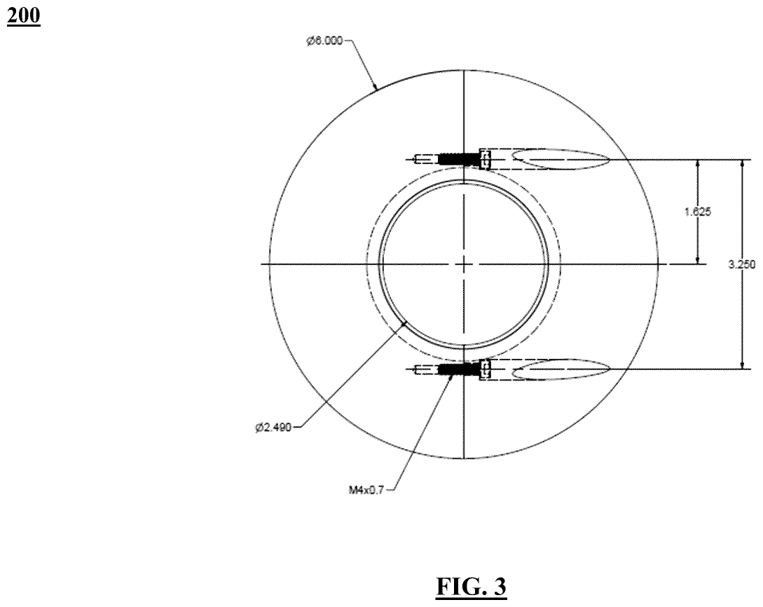

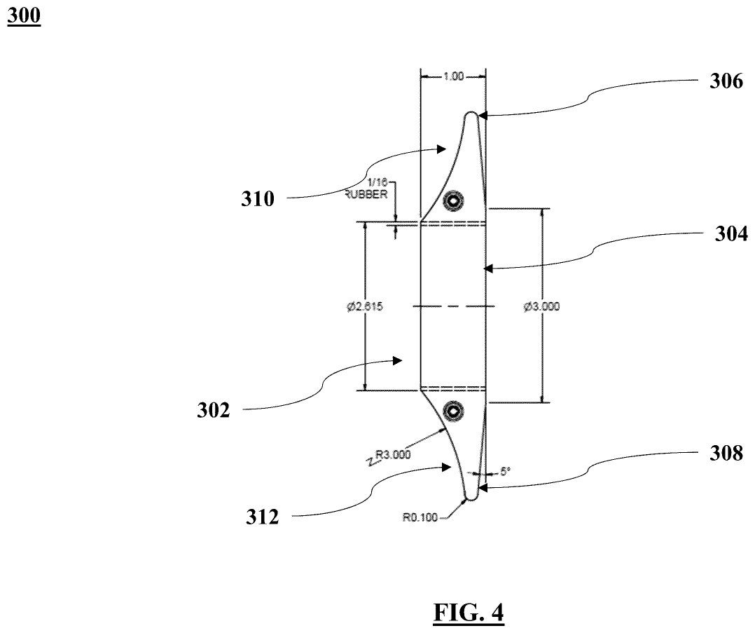

FIG. 3 illustrates a top planar view 200 of the creepage extender system 100, in accordance with various non-limiting embodiments of the present disclosure and FIG. 4 illustrates a side elevation view 300 of the creepage extender system 100, in accordance with various non-limiting embodiments of the present disclosure. The planar view 200 and the side elevation view 300 illustrate various representative proportions of the creepage extender system 100. The illustrated dimensions are non-limiting and various parts of the creepage extender system 100 may have any suitable proportion and dimension.

FIG. 4 illustrates a bottom surface 302 and a top surface 304 of the creepage extender system 100. The top surface 304 may have distal ends 306 and 308. As illustrated the distal ends 306 and 308 may be tilted at a given angle, for example, 5 degrees, relative to an imaginary line or a plane drawn from the center of the top surface. In doing so, if the creepage extender is positioned in the vertical plane whereby the bottom surface 304 becomes the top surface, any moisture accumulation (droplets) will accumulate towards the end and will fall off and the surface will be self-draining.

This provides the ability for shedding of water regardless of the direction of installation of the creepage extender system 100, in contrast to conventional sheds which would tend to trap water if the tool was in an inverted direction. i.e. on conventional shed design water shedding is only provided in one direction and the other side may collect water. Further, the bottom surface 302 may have exponentially decaying profiles 310 and 312. One benefit of having such exponentially decaying profiles is similar to the inclination of the distal ends whereby any moisture will accumulate towards the end and will fall off and will be self-draining.

Shed design affects streamer propagation and accordingly affects personnel safety. In general, two types of streamers have been identified: surface streamers and air streamers.

The shape of shed curves significantly affects the movement of electrical streamers on polymer insulators. Specifically, curved, larger sheds with a smaller fillet radius effectively block surface streamers, while air streamers can bypass the shed. Shed shape plays a role in determining streamer paths. Sharper curves reduce streamer stability, whereas larger curves allow for faster propagation. These factors directly influence flashover risks, with material properties also affecting the streamer's velocity.

Shed design can accordingly increase the electric field required for streamer propagation, making it more difficult for streamers to form and travel. Ultimately, shed design can effectively reduce the occurrence of flashovers. The creepage extender systems disclosed herein optimize the shape, dimensions, and materials to efficiently hinder streamer propagation. The creepage extender systems disclosed herein may be placed on both the energized and ground sides to provide additional protection. This approach prevents streamers from traveling in either direction, as streamers can originate from contaminated areas near the energized side or from the lineman.

It is contemplated that the term top surface and bottom surface discussed above are used arbitrarily and there may be situations where these are inverted to accommodate various field conditions and applications. The design of the creep extender 100 is such that they will function in either direction.

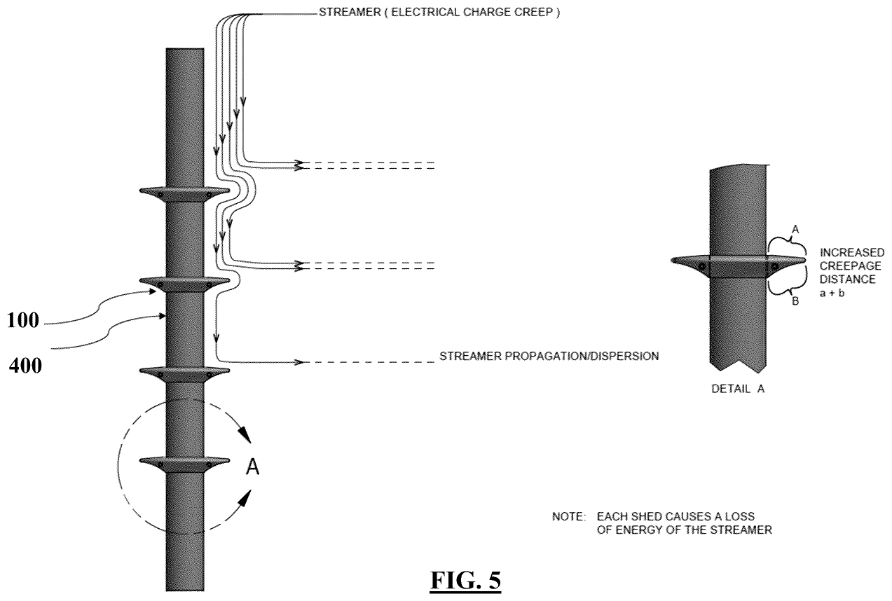

FIG. 5 illustrates creepage extender systems 100 mounted on an insulation tool 400, in accordance with various non-limiting embodiments of the present disclosure. In this embodiment, a plurality of creepage extender systems 100 have been mounted on the insulation tool 400. The creepage extender systems 100 may be installed in a series of three to four (or more) with an even spacing therebetween. To mount the creepage extender system 100, the first creepage extender portion 102 may be mounted on the insulation tool 400 at a given location. The second creepage extender portion 104 may be mounted opposite to the first creepage extender 102 portion. The first creepage extender portion 102 and the second creepage extender portion 104 may be coupled together.

The creepage extender systems 100 may serve the purpose of extending the creepage length to break electrical continuity in wet or contaminated conditions, thereby preventing potential harm to workers and the risk of short-circuiting the electrical system. Each creepage extender system 100 may cause a loss of energy of the streamer. The creepage extender systems 100 may provide consistent or decreasing voltage gradient along the length of the insulation tool 400 and improve worker safety. They may serve to as a visual reference to mark the MAD which may ensure the end-user stays within the limits of approach.

When the electrical charge moves along the insulation tool 400, it reaches the first inner portion 108 and the second outer portion 110 on the top surface 304 where it is either propagated into the surrounding air or, if any remaining charge is not shed, it might return towards the insulation tool 400 in a path flowing underneath the creepage extender system along the bottom surface 302. This may result in an extension of the creepage length and the interruption of electrical continuity. If the reduced electrical charge persists and keeps moving, the reduced electrical charge may encounter another creepage extender system 100, and this cycle continues until eventually, a significant amount of electrical charge is dispersed or propagated. Another benefit of using the creepage extender systems 100 is that a higher voltage stress is required to flashover the tools as compared to without using the creepage extender systems 100.

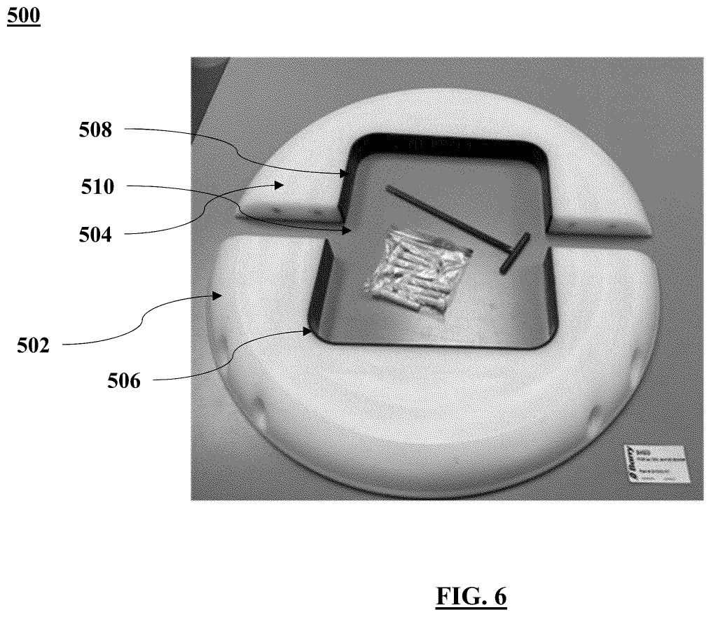

FIG. 6 illustrates another representative creepage extender system 500, in accordance with various non-limiting embodiments. The creepage extender system 500 may include a first portion 502 and a second creepage extender portion 504. In this non-limiting embodiment, inner portions 506 and 508 of the first creepage extender portion 502 and the second creepage extender portion 504 may define a first rectangular portion and a second rectangular portion respectively. Thereby, when the first creepage extender portion 502 is coupled to the second creepage extender portion 504, the defined aperture 510 to receive the insulation tools is rectangular.

The inner portion 506 has been illustrated to be equal to the inner portion 508. However, in various non-limiting embodiments, a length of the inner portion 506 may be longer or shorter than a length of the inner portion 508. Similarly, the length of the first outer portion 110 may be longer or shorter than the length of the second outer portion 118. That is, the inner portions 506 and 508 may not need to be of equal size. In other words, one of the first creepage extender portion 502 and the second creepage extender portion 504 may be smaller in size as compared to the other, while still maintaining the size of the aperture 510 and the overall size of the creepage extender system 500.

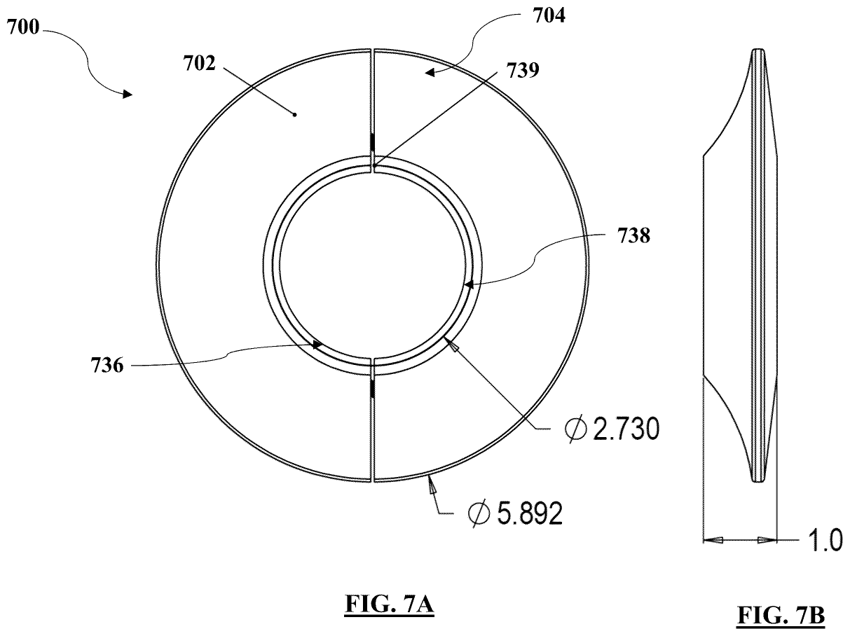

Referring now to FIGS. 7A and 7B, an exemplary creepage extender system 700 has a first portion 702 and a second portion 704. The portions 702 and 704 may comprise PVC. The creepage extender system 700 may have an outer diameter of about 5.9 inches, however it is understood that other sizes are within the scope of the present disclosure. For example, the creepage extender system 700 may have an outer diameter between about ¾ inches and 5 inches, for example 1 inch, 1¼ inches, 1½ inches, 2 inches, 2½ inches, and/or 3 inches. It is also understood that, when the creepage extender systems disclosed herein are configured to be installed on a boom, the dimensions of the creepage extender system are such that it can be assembled around the boom body. Accordingly, the creepage extender system may have a square or other cross-section and dimensions adapted for installation on a portion of the boom body. When the boom or the equipment comprises a plurality of sections having different diameter, or has a varying diameter or at least one variable axial length, the creepage extender systems installed thereon will have a varying aperture size adapted to the section size.

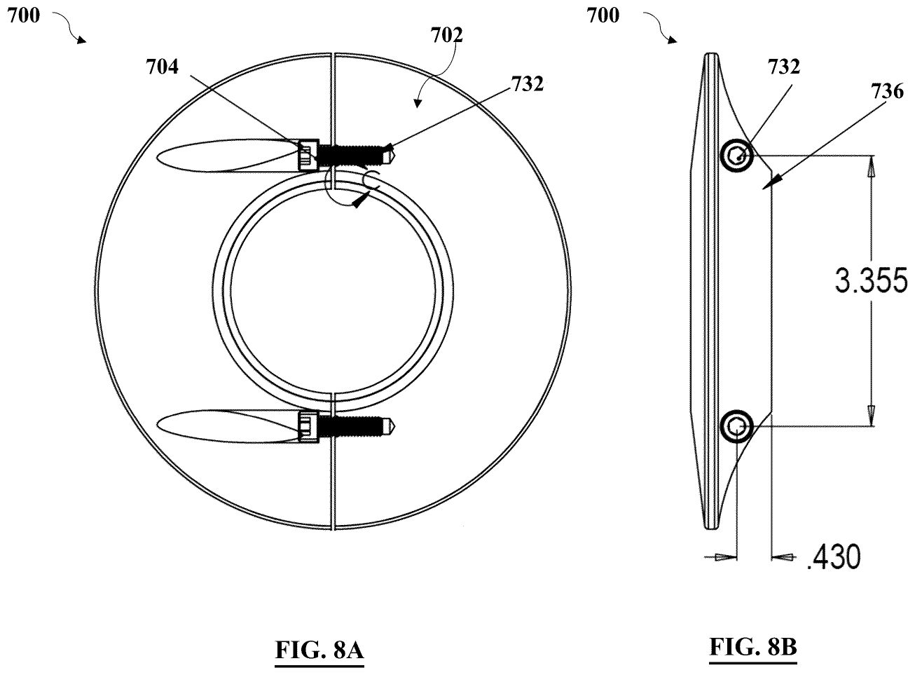

Referring now to FIGS. 8A and 8B, a view of the creepage extender system 700 of FIGS. 7A and 7B showing fasteners 732 is presented. The fasteners 732 may comprise glass-filled nylon and/or other suitable materials for providing insulating performance for the creepage extender system 700. As stated above, the fasteners 732 may be self-tapping, and accordingly a hole in portion 702 corresponding to the fastener hole in portion 704 may not be provided. Referring to FIG. 8B, the creepage extender system 700 may comprise a resilient and/or elastic and/or compressible layer provided on the first sector 736, which layer may extend longitudinally from the body, for example the PVC body of the creepage extender system 700.

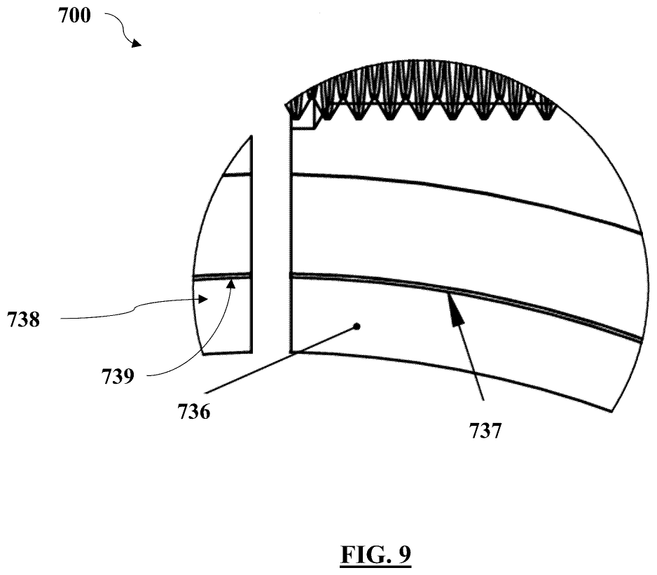

Referring now to FIG. 9, a detail of the creepage extender system 700 is shown. A first portion 736 of the resilient layer as described above is configured to abut a second portion 738 of the resilient layer when the creepage extender system is assembled, to provide for improved insulation, grip and watertightness, among other advantages. The resilient layer portions 736, 738 may be secured to the respective portions of the creepage extender system 700 using an adhesive 737, 739. The adhesive may be a double-sided tape, a polymer, for example polyurethane, or any other type of adhesive suitable for securing an elastic and/or compressible material to the shed body, for example for securing rubber to PVC.

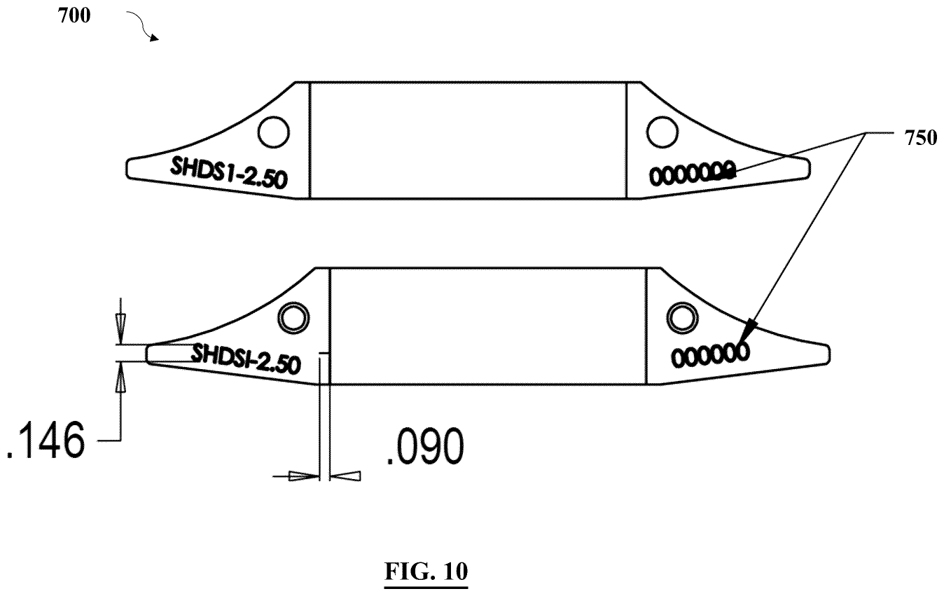

Referring to FIG. 10, side views of the creepage extender system 700 show that the creepage extender system 700 may comprise printed and/or etched indicia 750, for example lot numbers, manufacture dates, size and/or use recommendations, among others.

### Testing for Effectiveness

Various configurations of the creepage extender systems according to the present disclosure were tested using AC and DC power sources. Results indicate that the use of the extender systems disclosed herein improves the insulating performance of the tools upon which the systems are installed.

### Aerial Device Masts

Four sheds installed on an aerial device (boom truck) mast were tested at a very high voltage at a Manitoba Hydro facility using a DC source which has no capacitive coupling. Results shown in Table 1 indicate that having sheds installed yields leakage current values which are nearly 70% less than when no sheds are installed. This is a significant improvement in safety.

TABLE 1
Aerial Device-4 installed on 17 foot boom

| | Creepage | No |
|---|---|---|
| | Extenders | Creepage Extenders |
| | Installed | Installed |
| Applied Voltage | Leakage Current (μA) | Leakage Current (μA) |
| −800 kV DC dry | 0.07 | 0.22 |
| +800 kV DC dry | 0.09 | 0.25 |
| −800 kV DC wet | 0.07 | 0.23 |
| +800 kV DC wet | 0.04 | 0.21 |
| Average Leakage | 0.0675 | 0.2275 |
| Current | | |

### FRP Ladders

Creepage extender sheds were installed on an FRP ladder as follows: 3 sheds were installed per side, with 6 total sheds installed, followed by testing of one side of the ladder at a time at an applied voltage of approximately-105 kV DC. Results shown in Table 2 indicate that having sheds installed yields leakage current values which are nearly 68% less than when no sheds are installed.

TABLE 2
Insulating Ladder-3 sheds installed on 10 foot ladder
Note: All tests performed wet and for 1 min. duration

| | | Leakage Current (μA) | | | | |
|---|---|---|---|---|---|---|
| | | 2 foot section # , Sheds | | | | |
| | Applied DC | installed in sections 1, 3, 5 | | | | |
| Tool #, Side a or b | Voltage (kV) | 1 | 2 | 3 | 4 | 5 |
| 1, a no sheds | −104.6 | 0 | 0 | −2.7 | −1 | −1.5 |
| 1, a with sheds | −104.6 | 0 | 0 | 0 | −0.6 | −0.9 |
| 1, b no sheds | −105.2 | 0 | −0.2 | 0 | −1.5 | −2.6 |
| 1, b with sheds | −105 | 0 | −0.2 | 0 | −1.3 | 0 |
| 2, a no sheds | −104.6 | 0 | 0 | −2.7 | −1 | −1.5 |
| 2, a with sheds | −104.6 | 0 | 0 | 0 | −0.6 | −0.9 |
| 2, b no sheds | −105.2 | 0 | −0.2 | 0 | −1.5 | −2.6 |
| 2, b with sheds | −105 | 0 | −0.2 | 0 | −1.3 | 0 |

| | |
|---|---|
| Average Leakage | −0.3 |
| Current for all | |
| sections/tools/sides, | |
| with Sheds | |
| Average Leakage | −0.95 |
| Current for all | |
| sections/tools/sides, | |
| no Sheds | |

### FRP Poles

Results of testing the effectiveness of the creepage extender systems disclosed herein on FRP poles are shown in Table 3. Eighteen tests were conducted on various shed configurations installed on 2.5-inch FRP poles under dry and wet conditions at 75 kV AC. The results showed a nearly 40% reduction in leakage current when sheds were installed, with the most significant improvements observed in wet conditions. Even under dry conditions, the sheds offered measurable benefits.

TABLE 3

| HORIZONTAL 12 inch- | | |
|---|---|---|
| Applied voltage 75 kV- | | |
| AC | DRY Max (uA) | WET Max (uA) |
| No sheds | 62.50 | 99.23 |
| | 41.73 | 75.68 |
| With sheds | 55.83 | 60.59 |
| | 42.73 | 67.22 |

Therefore, the use of the creepage extender systems 100, 500 and 700 may yield numerous advantages. As previously discussed, the creepage extender systems 100, 500 and 700 are removable, providing a straightforward process for installation, removal, inspection, cleaning, and storage. The ability to easily remove them allows each tool to be customized at the work site as the creepage extender systems can be installed where required for the MAD based on the line voltage. The systems disclosed herein extend creepage distance, disrupt streamer discharge, shed moisture, and significantly reduce the risk of flashover during live line work when installed on insulating tools. Furthermore, the systems disclosed herein disrupt streamer propagation and velocity, providing an effective barrier, serve as a visual marker for Minimum Approach Distance (MAD), helping users stay within safe limits, act as a physical barrier, preventing users from accidentally sliding a tool through their hands and crossing the MAD, and protect hot sticks when laid flat or stored.

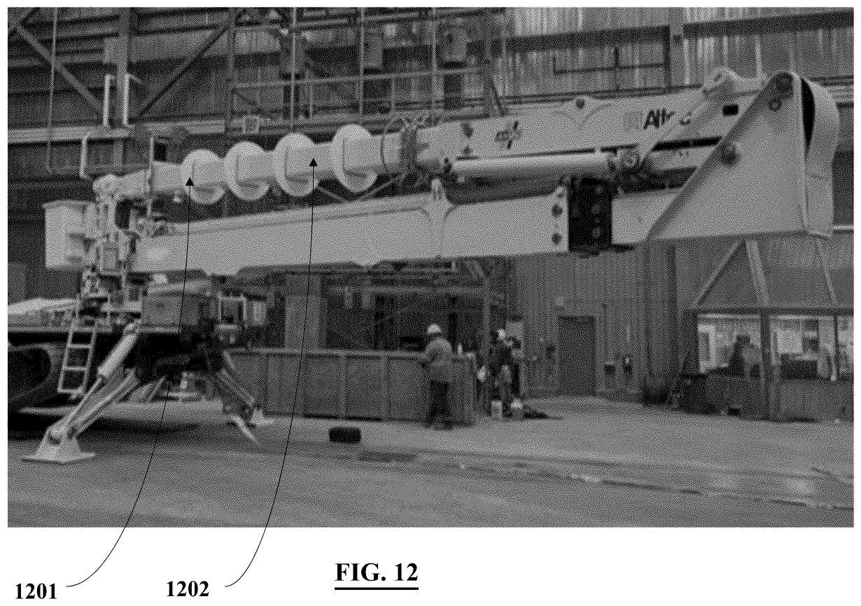

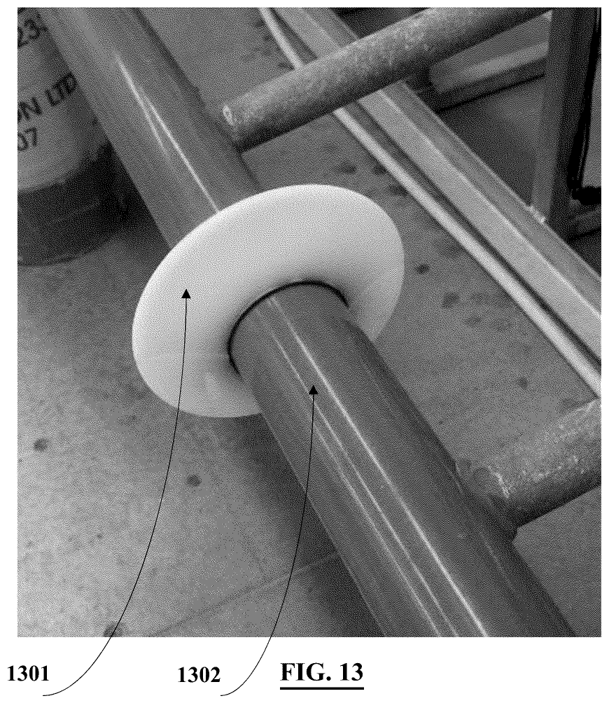

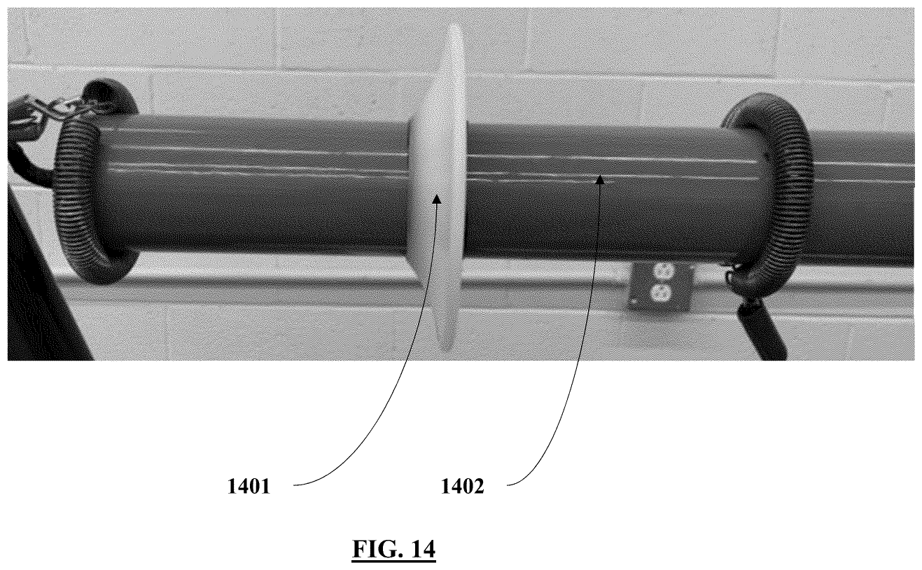

FIG. 12 shows an exemplary use of the creepage extender systems disclosed herein, wherein a plurality of creepage extender systems 1201 are installed on an aerial device boom 1202. FIG. 13 shows a creepage extender system 1301 installed on a ladder 1302. FIG. 14 shows a creepage extender system 1401 installed on a FRP pole 1402.

The systems are easily installed with two substantially symmetrical halves that fit securely around insulated tools such as poles, strain poles, link sticks, hot sticks, D.E.W. line insulative ropes, ladders, and aerial device booms. The system is simple to remove for inspection and cleaning, requiring no heat or adhesives. It is durable, maintains its shape during storage, and can be reused or recycled.

It should be expressly understood that not all technical effects mentioned herein need to be enjoyed in each implementation of the present technology. For example, implementations of the present technology may be implemented without the user enjoying some of these technical effects, while other non-limiting implementations may be implemented with the user enjoying other technical effects or none at all.

Modifications and improvements to the above-described implementations of the present technology may become apparent to those skilled in the art. The foregoing description is intended to be exemplary rather than limiting.

I/We claim:

1. A creepage extender system comprising:
a first creepage extender portion; and
a second creepage extender portion,
the second creepage extender portion being configured to be detachably coupled to the first creepage extender portion,
wherein, when the second creepage extender portion is coupled to the first creepage extender portion, the creepage extender system defines an aperture configured to receive an insulation tool.

2. The creepage extender system of claim 1, wherein:
the first creepage extender portion has a first inner portion and a first outer portion, the first inner portion having a first wall and a second wall separated by a first predefined distance,
the first outer portion defining a first outer sector; and
the second creepage extender portion has a second inner portion and a second outer portion,
the second inner portion having a third wall and a fourth wall separated by a second predefined distance,
the second outer portion defining a second outer sector.

3. The creepage extender of system claim 2, wherein the first wall and the second wall include through openings that extend from the first outer portion, configured to receive fasteners, and the third wall and the fourth wall include recesses configured to hold the fasteners.

4. The creepage extender system of claim 2, wherein the first wall, the second wall, the third wall, and the fourth wall define couplers.

5. The creepage extender system of claim 4, wherein the couplers are arranged in a snap fit arrangement.

6. The creepage extender system of claim 4, wherein the couplers are arranged to receive screws for securing together the first and second creepage extender portions.

7. The creepage extender system of claim 2, wherein the first inner portion further comprises a first inner sector defined between the first wall and the second wall and the second inner portion further comprises a second inner sector defined between the third wall and the fourth wall.

8. The creepage extender system of claim 7, wherein a length of the first inner sector is one of:
longer than a length of the second inner sector;
shorter than the length of the second inner sector; and
equal to the length of the second inner sector.

9. The creepage extender system of claim 2, wherein the first inner portion further comprises a first rectangular portion defined between the first wall and the second wall and the second inner portion further comprises a second rectangular portion defined between the third wall and the fourth wall.

10. The creepage extender system of claim 9, wherein a length of the first rectangular portion is one of:
longer than a length of the second rectangular portion;
shorter than the length of the second rectangular portion; and
equal to the length of the second rectangular portion.

11. The creepage extender system of claim 2, wherein a length of the first outer sector is one of:
longer than a length of the second outer sector;
shorter than the length of the second outer sector; and
equal to the length of the second outer sector.

12. The creepage extender system of claim 2, wherein the first inner portion and the second inner portion further comprise a layer of elastic material.

13. The creepage extender system of claim 2, wherein the first inner portion and the second inner portion further comprise a compressible layer comprising a compressible material, the compressible layer extending radially into at least a portion of the aperture.

14. The creepage extender system of claim 13, wherein the compressible layer is configured for at least partial compression between the insulation tool and at least one of the first and second creepage extender portions.

15. The creepage extender system of claim 1, wherein the aperture is at least one of: a circular aperture, a rectangular aperture, a triangular aperture, and an oval aperture.

16. A kit of parts comprising the creepage extender system of claim 1 together with assembly instructions.

17. The creepage extender system of claim 1, wherein the system comprises one or more materials selected from Ultra-High Molecular Weight Polyethylene, cast nylon, polyurethane, polytetrafluoroethylene, polyvinylchloride, polyvinyl ether, polypropylene, nylon, polycarbonate, HDPE, fiberglass, fiber-reinforced polymer, polyurethane and ceramic.
